(19) United States
(12) Patent Application Publication
(10) Pub. No.: US 2017/0242647 A1
(43) Pub. Date: Aug. 24, 2017

(54) INFORMATION PROCESSING DEVICE, INFORMATION PROCESSING METHOD AND NON-TRANSITORY COMPUTER READABLE MEDIUM

(71) Applicant: FUJI XEROX CO., LTD., Tokyo (JP)

(72) Inventors: Yuki NAKAMORI, Yokohama-shi (JP); Kazunori HORIKIRI, Yokohama-shi (JP); Yusuke KANO, Yokohama-shi (JP)

(73) Assignee: FUJI XEROX CO., LTD., Tokyo (JP)

(21) Appl. No.: 15/222,393

(22) Filed: Jul. 28, 2016

(30) Foreign Application Priority Data
Feb. 19, 2016 (JP) 2016-029493

(51) Int. Cl. G06F 3/14; G06F 3/0481; G06F 3/147; G06F 3/0484

(52) U.S. Cl. CPC G06F 3/1454; G06F 3/04845; G06F 3/0481; G06F 3/147

(57) ABSTRACT

An information processing device includes an extraction unit that extracts a history of operations performed on a sticky note which is attached to a pasteboard, and a presentation unit that, in a case that the history of the operations satisfies a predetermined condition, performs presentation which indicates a situation in a meeting corresponding to the predetermined condition.

### CROSS-REFERENCE TO RELATED APPLICATIONS

This application is based on and claims priority under 35 USC 119 from Japanese Patent Application No. 2016-029493 filed on Feb. 19, 2016.

### BACKGROUND

### Technical Field

The present invention relates to an information processing device, an information processing method and a non-transitory computer readable medium storing an information processing program.

### SUMMARY

An aspect of the invention provides an information processing device including: an extraction unit that extracts a history of operations performed on a sticky note which is attached to a pasteboard; and a presentation unit that, in a case that the history of the operations satisfies a predetermined condition, performs presentation which indicates a situation in a meeting corresponding to the predetermined condition.

### BRIEF DESCRIPTION OF THE DRAWINGS

Exemplary embodiments of the present invention will be described in detail based on the following figures, wherein:

FIG. 1 is a conceptual module configuration diagram illustrating an example of a configuration according to an embodiment;

FIG. 2 is an explanatory diagram illustrating an example of the configuration of a system according to the exemplary embodiment;

FIGS. 3A to 3D are explanatory diagrams illustrating examples of the configurations of the system according to the exemplary embodiment;

FIGS. 4A to 4C are explanatory diagrams illustrating an example of a conference room or the like and examples of the use of a display device and a personal terminal according to the exemplary embodiment;

FIG. 5 is an explanatory diagram illustrating an example of the data structure of a sticky note information table;

FIG. 6 is an explanatory diagram illustrating an example of the data structure of a pasteboard information table;

FIG. 7 is an explanatory diagram illustrating an example of the data structure of a log table;

FIG. 8 is an explanatory diagram illustrating an example of the data structure of a condition table;

FIG. 9 is a flowchart illustrating an example of a process according to the exemplary embodiment;

FIG. 10 is a flowchart illustrating an example of a process according to the exemplary embodiment;

FIG. 11 is a flowchart illustrating an example of a process according to the exemplary embodiment;

FIG. 12 is a flowchart illustrating an example of a process according to the exemplary embodiment;

FIG. 13 is a flowchart illustrating an example of a process according to the exemplary embodiment;

FIG. 14 is a flowchart illustrating an example of a process according to the exemplary embodiment;

FIG. 15 is a flowchart illustrating an example of a process according to the exemplary embodiment;

FIG. 16 is a flowchart illustrating an example of a process according to the exemplary embodiment; and

FIG. 17 is a block diagram illustrating an example of the hardware configuration of a computer which realizes the exemplary embodiment.

### DETAILED DESCRIPTION

Hereinafter, examples of embodiments, which are suitable to realize the present invention, will be described with reference to the accompanying drawings.

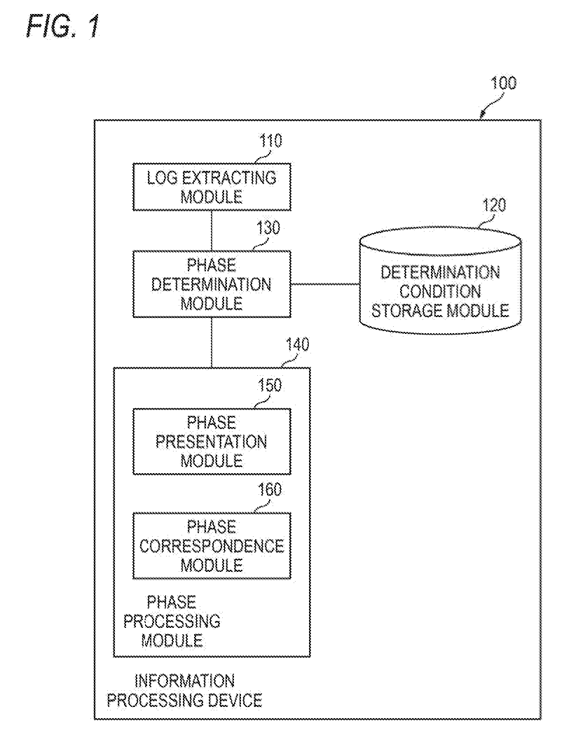

FIG. 1 is a conceptual module configuration diagram illustrating an example of a configuration according to an embodiment.

Meanwhile, modules typically indicate components, such as software (computer program) and hardware, which can be logically separated. Accordingly, modules in the exemplary embodiment indicate modules in a hardware configuration in addition to modules in a computer program. Therefore, in the exemplary embodiment, computer programs (a program which causes a computer to execute respective procedures, a program which causes the computer to function as respective units, and a program which causes the computer to realize respective functions) which are caused to function as the modules, systems, and methods are described. Meanwhile, for convenience of explanation, the words “store”, “cause to be stored”, and equivalent words thereof are used. In a case that the exemplary embodiment corresponds to a computer program, the words mean to store in a storage device or to perform control to be stored in the storage device. In addition, although modules may correspond to functions one by one, one module may be formed by one program, plural modules may be formed by one program, or, on the contrary, one module may be formed by plural programs for implementations. In addition, plural modules may be executed by one computer or one module may be executed by plural computers using computers in a distributed or parallel environment. Meanwhile, one module may include another module. In addition, hereinafter, “connection” is used in a case of logical connection (transmission and reception of data, instruction, reference relationship between data, or the like) in addition to physical connection. “Predetermined” indicates “determined before a process which is a target is performed”, and is used while including a meaning of “determined according to a situation and a state at that time or according to a situation and a state until that time if a target process is not performed even in a case after a process according to the exemplary embodiment starts as well as a case before the process according to the exemplary embodiment starts”. In a case that there are plural “predetermined values”, the predetermined values may be different values, respectively, or two or more values (apparently including all the values) may be the same. In addition, a description, which has a meaning of “in a case of A, perform B”, is used as meaning “determine whether or not it is A, and perform B in a case that it is determined to A”. However, a case in which it is not necessary to determine whether or not it is A is excluded.

In addition, a system or a device includes a configuration which is realized by one computer, hardware, one device, or the like in addition to a configuration in which plural computers, hardware, devices, or the like are connected through a communication unit, such as a network (including communication connection of one-to-one correspondence). The “device” and the “system” are used as synonymous terms. It is apparent that the “system” does not include a mere social “structure” (social system) which is an artificial decision.

In addition, in a case of each process being performed by each module or a case in which plural processes are performed in a module, target information is read from a storage device for each process, the process is performed, and the result of the process is written in the storage device. Accordingly, there is a case in which reading from the storage device before the process is performed and writing in the storage device after the process is performed may not be described. Meanwhile, here, the storage device may include a hard disk, a random access memory (RAM), an external storage medium, a storage device connected through a communication line, a register in a central processing unit (CPU), and the like.

An information processing device 100 according to the exemplary embodiment performs a process relevant to a sticky note which is used in a meeting, and includes a log extracting module 110, a determination condition storage module 120, a phase determination module 130, and a phase processing module 140, as illustrated in the example of FIG. 1.

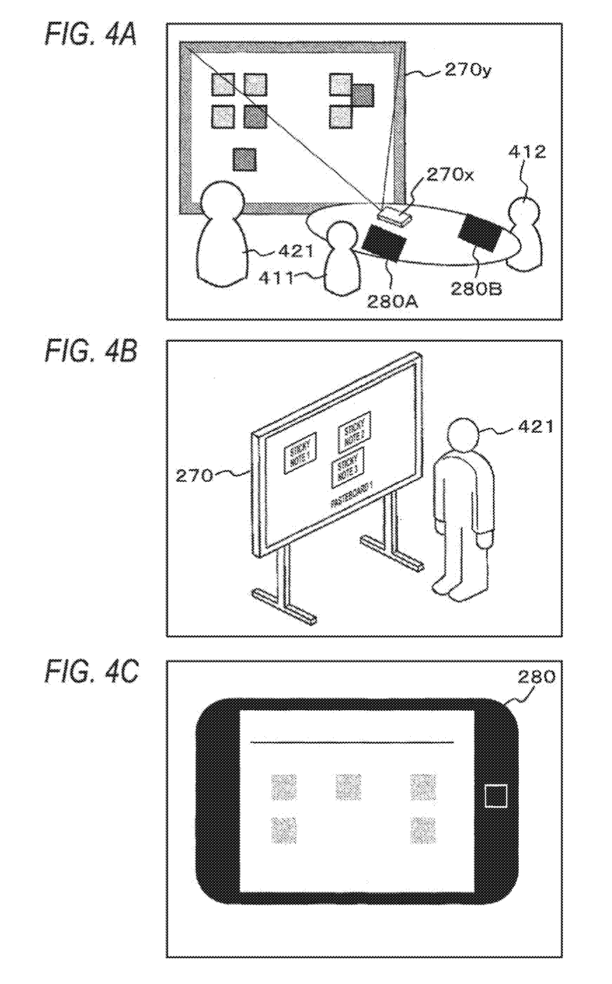

The information processing device 100 is used for, specifically, a meeting (a workshop, a conference, an idea extraction meeting, a review meeting, or the like) which is performed by a facilitator (generally, a person) and plural participants using sticky notes. The participants prepare the sticky notes in which ideas or the like are written using terminal devices (personal terminals 280 which will be described later) as participant terminals. Generally, as illustrated in an example of FIG. 4, the personal terminals 280 include a personal terminal 280A, a personal terminal 280B (hereinafter, referred to as the personal terminals 280 as a representative), and the like, and thus the plural personal terminals 280 are provided. Further, a display device 270 receives sticky notes from the personal terminals 280, and attaches the sticky notes on a pasteboard (or background). The facilitator progresses the meeting using a common screen which is the display device of the display device 270 in such a way as to determine or change the locations of the sticky notes on the pasteboard, to collect the sticky notes (also referred to as the association of a first sticky note with a second sticky note, the formation of a group, and the like), and to prepare sticky note information by herself or himself. Meanwhile, in the exemplary embodiment, the facilitator is included in the participants.

In the meeting, there are some situations (hereinafter, also referred to as phases). Functions which are acquired for the respective phases are different from each other. There is a method of causing the facilitator or the like to designate the phases. However, if the facilitator concentrates on the workshop, it is difficult for the facilitator to operate a system.

The facilitator determines the situation of the workshop through experience or the like, and appropriately takes action for a problem depending on individual experience or capacity. That is, in order to refer to a way of proceeding the workshop or in order to analyze the way of proceeding a meeting after the meeting ends, it is helpful for the facilitator to know the phase. In addition, in a case of providing a piece of advice to a desired group while checking the situations of plural groups, the phase is not understood if content is not checked. If the phase is determined, it is easy to provide exact advice.

There are plural phases, and the phases include, for example, a first phase, a second phase subsequent to the first phase, and the like.

Here, the first phase includes, for example, idea issue, release, sharing, and the like. The “idea issue” is a step of, specifically, preparing sticky notes or the like. The “release” is a step of exchanging information or opinions as much as possible in order to accomplish the goal of the conference, and utilizing, specifically, a forced association method for extracting an innovative idea in brainstorming or the like. The “sharing” is a step of, specifically, acquiring mutual understanding. For example, a purpose or goal, the participants and schedules, discussion subject information, and the like are checked.

The second phase includes, for example, analysis and structuralization, convergence, or the like. The “analysis and structuralization” is a step of performing engagement and arrangement. Specifically, grouping of sticky notes is performed. The “convergence” is a step of performing arrangement while redeeming the exchanged information and the opinions (content written in the sticky notes) without omission and leakage. In addition, a step of obtaining a consensus by performing selection from the arranged sticky notes may be included.

It is important for the facilitator to discriminate between the first phase and the second phase. If the two phases are not clearly discriminated, ideas are reviewed and evaluated (converged) while the ideas are issued (released). As a result, a meeting ends before a sufficient number of ideas are issued. In order to find a fresh solution, first, it is important to squeeze out as many ideas as possible in the “release” step.

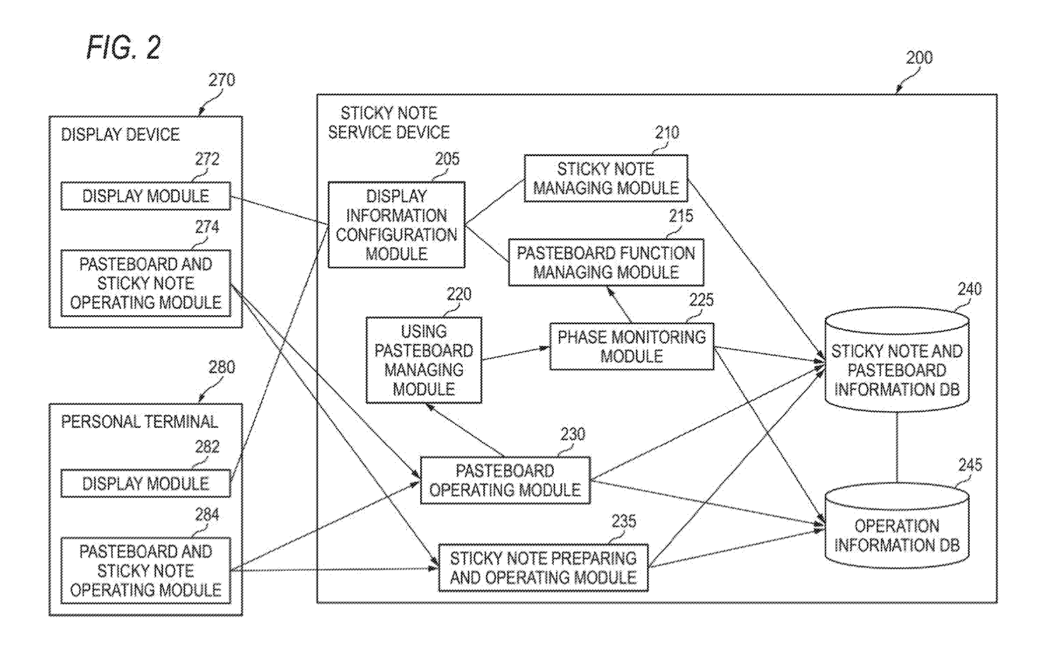

The log extracting module 110 is connected to the phase determination module 130. The log extracting module 110 extracts the history of operations (generally, also referred to as the log) performed on the sticky notes which are attached to the pasteboard. The log extracting module 110 extracts the history of the operations from a storage device (for example, an operation information DB 245 or the like, which will be described later using an example of FIG. 2) which stores the history of the operations. The “history of the operations” includes one of (1) an operation in a state before the sticky notes are attached to the pasteboard, (2) an operation of attaching the sticky notes to the pasteboard, and (3) an operation in a state after the sticky notes are attached to the pasteboard, or the combination thereof. In addition, the “history of the operations” includes any one of (1) the history of the operations in the display device 270, (2) the history of the operations in the personal terminals 280, and the combination thereof.

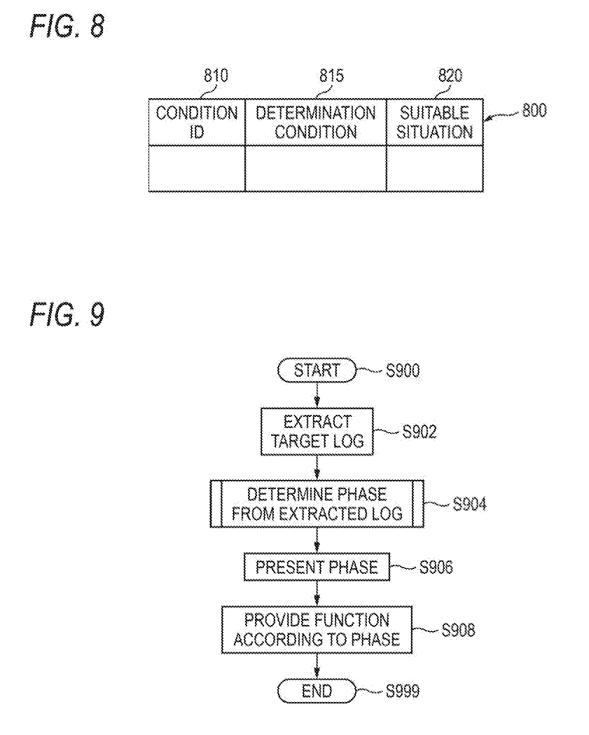

The determination condition storage module 120 is connected to the phase determination module 130. The determination condition storage module 120 stores conditions for determining situations. For example, the determination condition storage module 120 stores a condition table 800. FIG. 8 is an explanatory diagram illustrating an example of the data structure of the condition table 800. The condition table 800 includes a condition ID field 810, a determination condition field 815, and a suitable situation field 820.

The condition ID field 810 stores information (condition ID) which uniquely identifies a condition in the exemplary embodiment.

The determination condition field 815 stores a predetermined determination condition. For example, the determination condition includes (1) the predetermined condition which is determined to be the first situation in a case that the number of added sticky notes in a predetermined period is equal to or larger than a predetermined threshold, (2) the first situation in a case that the predetermined condition indicates that a ratio of the number of movement operations in a predetermined period from when the sticky note is pasted to the number of movement operations is equal to or larger than a predetermined threshold, (3) the second situation together with the first situation in a case that a sticky note movement distance is equal to or larger than a predetermined threshold in the first situation, (4) the end of the first situation in a case that the number of sticky notes which are not transmitted in a personal terminal is equal to or smaller than a predetermined threshold, (5) transition to the second situation in a case that the number of pasted sticky notes in a predetermined period is equal to or smaller than a predetermined threshold and a ratio of the number of sticky note movements to the number of pasted sticky notes is equal to or larger than a predetermined threshold, and (6) the second situation in a case that voting starts.

The suitable situation field 820 stores a suitable situation in order to apply the determined condition. For example, the situation includes a case in which the number of sticky notes pasted to the pasteboard is equal to or greater than a predetermined number, a case in which a predetermined time (for example, 5 minutes or the like) elapses after a meeting starts, a case in which the number of participants of the meeting is equal to or greater or equal to or smaller than the predetermined number, and the like. A method of using the suitable situation field 820 includes a method of performing determination using the determination condition in the determination condition field 815 in a case that the suitable situation in the suitable situation field 820 is satisfied.

The phase determination module 130 is connected to the log extracting module 110, the determination condition storage module 120, and the phase processing module 140. The phase determination module 130 determines whether or not the history of the operations, which is extracted by the log extracting module 110, satisfies the predetermined condition in the determination condition storage module 120. For example, as described above, the phase determination module 130 uses the determination condition in the determination condition field 815 of the condition table 800.

In addition, the phase determination module 130 may change the predetermined threshold in the predetermined condition according to the number of people who participate in the meeting or according to whether or not the meeting is in progress. A method of determining “whether or not the meeting is in progress” includes determining a newly opened meeting in a case that the number of sticky notes pasted to the pasteboard at a time point in which the meeting starts is equal to or smaller than the predetermined number, and determining a continuously opened meeting from a previous meeting in other cases (a case in which the number of sticky notes pasted to the pasteboard at a time point in which the meeting starts is equal to or greater than the predetermined number). Further, in a case of the continuously opened meeting from the previous meeting, the predetermined threshold may be set such that a possibility that it is determined to be the first phase becomes low.

The phase processing module 140 includes a phase presentation module 150 and a phase correspondence module 160, and is connected to the phase determination module 130. In a case that the history of the operations satisfies the predetermined condition, the phase presentation module 150 performs presentation which indicates that the situation in a meeting corresponds to the condition. Specifically, the presentation relevant to the situation is performed using the result of a determination acquired by the phase determination module 130. The situation to be presented includes the end of the first situation, transition to the second situation, and the like, in addition to the first situation and the second situation. In addition, the phase presentation module 150 may perform presentation about a situation which is the result of the determination acquired by the phase determination module 130 as a Key Performance Indicator (KPI). The presentation includes display on a display device such as a liquid crystal display which is included in the information processing device 100, output of a sound from a sound output device such as a speaker, printing performed by a printing device such as a printer, vibration performed by a vibrating device, and the like.

In addition, the presentation destination of the phase presentation module 150 may include a predetermined personal terminal 280. For example, presentation may be performed on the personal terminal 280 which is used by the facilitator. It is possible for only the facilitator to understand the situation of the meeting without other participants' knowledge.

The phase correspondence module 160 performs a process according to the situation which is the result of the determination acquired by the phase determination module 130. For example, in a case that the first situation is longer than the predetermined period, transition to the second situation may be prompted. In addition, the display position or the ranking of an instruction (command) may be changed according to the situation. For example, an instruction relevant to sticky note preparation may be placed at a position at which the instruction is easily selected in a case of the first situation, and the instruction relevant to sticky note preparation may be displayed at a higher position in a case that the instruction is displayed in a list form. An instruction relevant to sticky note movement and grouping may be placed at a position at which the instruction is easily selected in a case of the second situation, and the instruction relevant to sticky note movement and grouping may be placed at a higher position in a case that the instruction is displayed in the list form.

In addition, the phase correspondence module 160 may change the pasteboard according to the situation. For example, a blank pasteboard may be used in the first situation, and a tabular pasteboard may be used in the second situation.

FIG. 2 is an explanatory diagram illustrating an example of the system configuration according to the exemplary embodiment. The example of the system configuration includes a sticky note service device 200, a display device 270, and the personal terminals 280.

The sticky note service device 200 includes a display information configuration module 205, a sticky note managing module 210, a pasteboard function managing module 215, a using pasteboard managing module 220, a phase monitoring module 225, a pasteboard operating module 230, a sticky note preparing and operating module 235, a sticky note and pasteboard information DB 240, and an operation information DB 245. The sticky note service device 200 uses the information processing device 100 illustrated in the example of FIG. 1 as the phase monitoring module 225, and displays a format which is incorporated in sticky note service device 200. That is, the modules and the like in the information processing device 100 are included in the phase monitoring module 225.

The display information configuration module 205 is connected to the sticky note managing module 210, the pasteboard function managing module 215, the display module 272 of the display device 270, and the display module 282 of the personal terminal 280. The display information configuration module 205 creates the pieces of display information (display images) of the sticky notes which are pasted to the pasteboard, and displays the display information on the display device, such as a liquid crystal display, of the display device 270 or the personal terminals 280.

The sticky note managing module 210 is connected to the display information configuration module 205 and the sticky note and pasteboard information DB 240. The sticky note managing module 210 manages sticky notes which are prepared by the personal terminals 280 or the display device 270.

The pasteboard function managing module 215 is connected to the display information configuration module 205 and the phase monitoring module 225. The pasteboard function managing module 215 manages the function of the pasteboard which is used in the meeting. For example, the pasteboard function managing module 215 controls the position to which the sticky note is pasted according to the pasteboard.

The using pasteboard managing module 220 is connected to the phase monitoring module 225 and the pasteboard operating module 230. The using pasteboard managing module 220 manages the pasteboard which is used in the meeting. For example, a pasteboard, which is selected according to an operation performed by the user (mainly the facilitator) of the display device 270, is used.

The phase monitoring module 225 is connected to the pasteboard function managing module 215, the using pasteboard managing module 220, the sticky note and pasteboard information DB 240, and the operation information DB 245. The phase monitoring module 225 has the function of the information processing device 100 which is illustrated in the above-described example of FIG. 1.

The pasteboard operating module 230 is connected to the using pasteboard managing module 220, the sticky note and pasteboard information DB 240, the operation information DB 245, the pasteboard and sticky note operating module 274 of the display device 270, and the pasteboard and sticky note operating module 284 of the personal terminal 280. The pasteboard operating module 230 performs a process on the pasteboard according to the operation performed in the display device 270 or the personal terminal 280 by the user. In cases in which the pasteboard is set and exchanged and the pasteboard has a function (for example, control of the position, to which the sticky note is pasted, or the like as described above), the pasteboard operating module 230 performs a process according to the function.

The sticky note preparing and operating module 235 is connected to the sticky note and pasteboard information DB 240, the operation information DB 245, the pasteboard and sticky note operating module 274 of the display device 270, and the pasteboard and sticky note operating module 284 of the personal terminal 280. The sticky note preparing and operating module 235 prepares sticky note, edits the content of the sticky notes, and performs the operations (changing or grouping movement, enlargement and reduction, and display format (including a shape, a pattern, a color, the combination thereof, or the dynamic change thereof (for example, flash, animation, or the like))) on the sticky notes according to the operation performed in the display device 270 or the personal terminal 280 by the user.

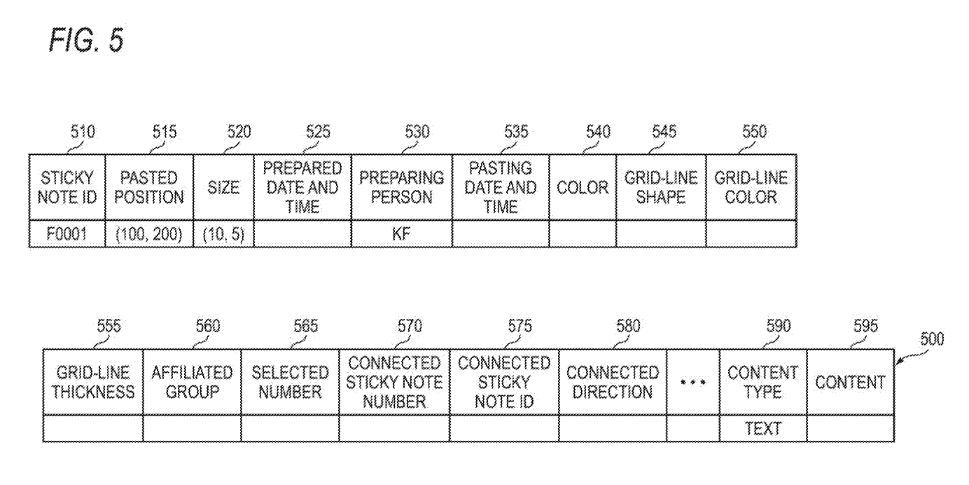

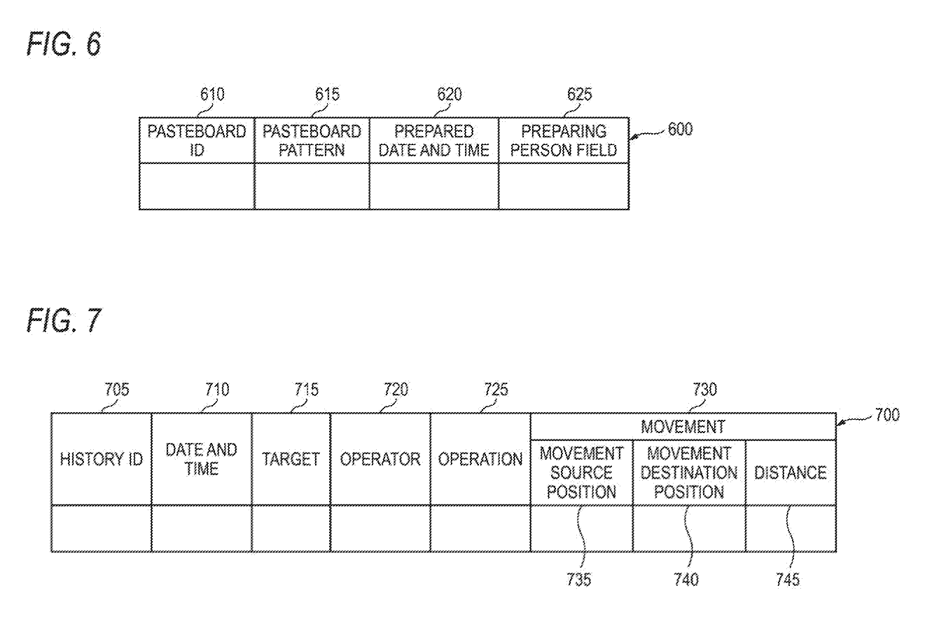

The sticky note and pasteboard information DB 240 is connected to the sticky note managing module 210, the phase monitoring module 225, the pasteboard operating module 230, the sticky note preparing and operating module 235, and the operation information DB 245. The sticky note and pasteboard information DB 240 stores pieces of information relevant to the sticky notes (including attribute information) and information relevant to the pasteboard. For example, the sticky note and pasteboard information DB 240 stores a sticky note information table 500 illustrated in an example of FIG. 5 and a pasteboard information table 600 illustrated in an example of FIG. 6.

FIG. 5 is an explanatory diagram illustrating an example of the data structure of the sticky note information table 500. The sticky note information table 500 includes a sticky note ID field 510, a pasted position field 515, a size field 520, a prepared date and time field 525, a preparing person field 530, a pasting date and time field 535, a color field 540, a grid-line shape field 545, a grid-line color field 550, a grid-line thickness field 555, an affiliated group field 560, a selected number field 565, a connected sticky note number field 570, a connected sticky note ID field 575, a connected direction field 580, a content type field 590, and a content field 595. The sticky note ID field 510 stores information (sticky note ID: IDentification) for uniquely identifying a sticky note in the exemplary embodiment. The pasted position field 515 stores a position to which the sticky note is pasted. That is, the pasted position field 515 stores a position on the pasteboard. For example, the position indicates coordinates in an XY coordination system of the pasteboard. Specifically, the position is specified by a movement process of the sticky note preparing and operating module 235. The size field 520 stores the size of the sticky note. For example, in a case that the sticky note to be displayed has a rectangular shape, the width and height of the rectangle are stored. The prepared date and time field 525 stores a date and time (year, month, date, time, minute, second, less than the second, or the combination thereof) when the sticky note is prepared. The preparing person field 530 stores a person (preparing person ID) who prepares the sticky note. Otherwise, an information processing device (the device ID of the sharing sticky note display device 270 or the personal terminal 280), in which the sticky note is prepared, may be stored. The pasting date and time field 535 stores a date and time when the sticky note is pasted to the pasteboard. The color field 540 stores the display color of the sticky note. The grid-line shape field 545 stores the shape (a solid line, a dotted line, a broken line, a wavy line, a double line, or the like) of a grid-line in the display of the sticky note. The grid-line color field 550 stores the color of the grid-line in the display of the sticky note. The grid-line thickness field 555 stores the thickness of the grid-line in the display of the sticky note. The affiliated group field 560 stores information relevant to a group to which the sticky note belongs. For example, the affiliated group field 560 may store information which indicates whether or not the sticky note belongs to a group, and, in a case that the sticky note belongs to a group, may store a group ID, another sticky note ID which belongs to the group, or the like. The selected number field 565 stores the number of times in which the sticky note is selected. For example, the number may be the number of times which is selected by an operation of selecting a subject of discussion. The connected sticky note number field 570 stores the number of sticky notes which are connected to the sticky note. The subsequent connected sticky note ID field 575 and the connected direction field 580 are repeated as many as the number of connected sticky notes. The connected sticky note ID field 575 stores the sticky note IDs of the connected sticky notes of the sticky note. The connected direction field 580 stores the connected direction of the sticky note and the immediately before sticky note of the connected sticky note ID field 575. The sticky note (or the immediately before sticky note of the connected sticky note ID field 575) may include information indicative of any one of an upper stream (connection source) and a lower stream (connection destination), or the sticky note ID of a sticky note in the upper stream (or the lower stream). In addition, in a case of non-oriented connection, the connected direction field 580 may be blank (NULL) or the connected direction field 580 may not exist. The content type field 590 stores the content type (text information, vector data which indicates handwritten characters, a figure, or the like, sound information, still image information, such as a picture, video information, or information which indicates the combination thereof) of the sticky note. The content field 595 stores content which is written in the sticky note. Meanwhile, in a state in which the sticky note is not pasted to the pasteboard, the pasted position field 515 or the like may be blank (NULL) or may have a predetermined value (default value).

FIG. 6 is an explanatory diagram illustrating an example of the data structure of the pasteboard information table 600. The pasteboard information table 600 includes a pasteboard ID field 610, a pasteboard pattern field 615, a prepared date and time field 620, and a preparing person field 625. In the exemplary embodiment, the pasteboard ID field 610 stores information (pasteboard ID) for uniquely identifying a pasteboard. The pasteboard pattern field 615 stores a pasteboard pattern. For example, the pasteboard pattern includes a blank, a tabular pattern, and the like. Specifically, in a case of the tabular pattern, control is performed such that a sticky note is pasted to a cell in the table as described above. The prepared date and time field 620 stores a date and time when the pasteboard is prepared. The preparing person field 625 stores a person who prepares the pasteboard.

The operation information DB 245 is connected to the phase monitoring module 225, the pasteboard operating module 230, the sticky note preparing and operating module 235, and the sticky note and pasteboard information DB 240. The operation information DB 245 stores the history of operations. For example, the operation information DB 245 stores a log table 700 illustrated in an example of FIG. 7. FIG. 7 is an explanatory diagram illustrating an example of the data structure of the log table 700. The log table 700 includes a history ID field 705, a date and time field 710, a target field 715, an operator field 720, an operation field 725, and a movement field 730. The movement field 730 includes a movement source position field 735, a movement destination position field 740, and a distance field 745. In the exemplary embodiment, the history ID field 705 stores information (history ID) for uniquely identifying a history. The date and time field 710 stores a date and time (year, month, date, time, minute, second, less than the second, or the combination thereof) when the history is generated (or the operations are performed). The target field 715 stores the target (a sticky note ID, a pasteboard ID, or the like) of an operation. The operator field 720 stores an operator who performs the operation. The operation field 725 stores the operation. The movement field 730 stores information relevant to a movement operation. The movement source position field 735 stores a movement source position (coordinates). The movement destination position field 740 stores a movement destination position (coordinates). The distance field 745 stores a distance. The distance may be a straight-line distance or an actually moved distance (for example, in a case of zigzag movement, the length of the trace).

The display device 270 includes a display module 272, and a pasteboard and sticky note operating module 274. The display device 270 is mainly used by the facilitator and includes, for example, a liquid crystal display or the like of a large screen so as to be clearly visible to the participants.

The display module 272 is connected to the display information configuration module 205 of the sticky note service device 200. The display module 272 performs display on the display device according to display control performed by the display information configuration module 205 of the sticky note service device 200 or an operation performed by the user.

The pasteboard and sticky note operating module 274 is connected to the pasteboard operating module 230 and the sticky note preparing and operating module 235 of the sticky note service device 200. The pasteboard and sticky note operating module 274 receives the operation performed on the pasteboard and the sticky note by the user, and transmits the operation to the pasteboard operating module 230 or the sticky note preparing and operating module 235 of the sticky note service device 200 according to whether the operation target is the pasteboard or the sticky note.

The personal terminal 280 includes a display module 282 and a pasteboard and sticky note operating module 284. The personal terminal 280 is used by the participants of the meeting, and includes, for example, a tablet-type terminal or the like so as to be easily handled by the participants.

The display module 282 is connected to the display information configuration module 205 of the sticky note service device 200. The display module 282 performs display control by the display information configuration module 205 of the sticky note service device 200 or performs display on the display device according to the operation or the like performed by the user.

The pasteboard and sticky note operating module 284 is connected to the pasteboard operating module 230 and the sticky note preparing and operating module 235 of the sticky note service device 200. The pasteboard and sticky note operating module 284 receives the operation performed on the pasteboard and the sticky note by the user, and transmits the operation to the pasteboard operating module 230 or the sticky note preparing and operating module 235 of the sticky note service device 200 according to whether the operation target is the pasteboard or the sticky note.

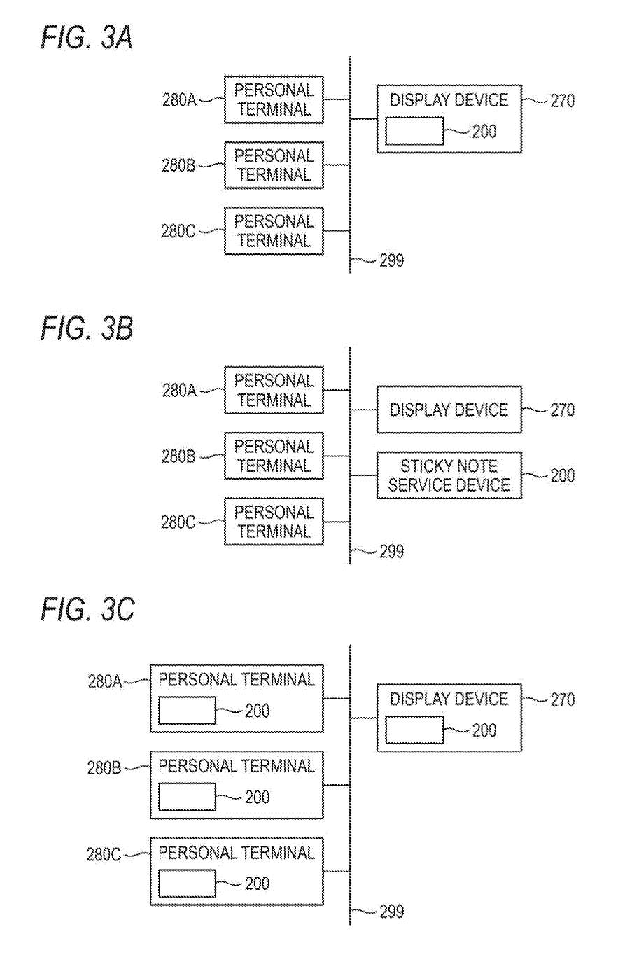

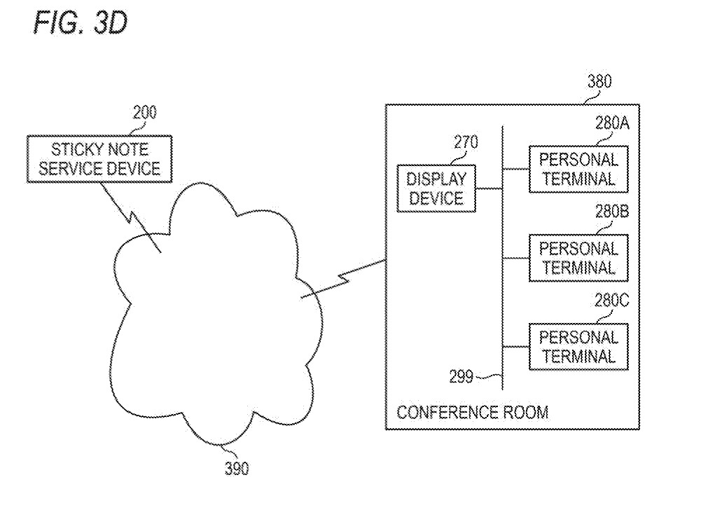

FIGS. 3A to 3D are explanatory diagrams illustrating an example of the configuration of a sticky note system according to the exemplary embodiment. The display device 270 generally includes a display device having a large screen, and is operated by the facilitator. The display device can be viewed by all the participants. The personal terminals 280 are operated by the participants in the meeting, and are generally possessed by the respective participants one by one. For example, tablet-type terminals or the like are used as the personal terminals 280.

In an example of FIG. 3A, the display device 270 includes the sticky note service device 200. Further, the display device 270, the personal terminal 280A, the personal terminal 280B, and the personal terminal 280C are connected to each other through the communication line 299. The communication line 299 may be a wireless line, a wired line, or the combination thereof, and may be, for example, the Internet, the intranet, or the like as a communication infrastructure. In this case, the sticky note service device 200 performs a process on the pasteboard and the sticky note which are displayed on the screen of the display device 270. Further, the display of the screen of the display device 270 is transmitted to each of the personal terminals 280.

In an example of FIG. 3B, the sticky note service device 200, the display device 270, the personal terminal 280A, the personal terminal 280B, and the personal terminal 280C are connected to each other through the communication line 299. In this case, the display device 270 and the respective personal terminals 280 use the sticky note service device 200 through the communication line 299. The pasteboards and sticky notes are displayed on the screens of the display device 270 and the respective personal terminals 280 under the control of the sticky note service device 200. In addition, the function performed by the sticky note service device 200 may be realized as a cloud service.

In an example of FIG. 3C, the display device 270 and the respective personal terminals 280 include the sticky note service devices 200. The display device 270, the personal terminal 280A, the personal terminal 280B, and the personal terminal 280C are connected to each other through the communication line 299. In this case, the respective sticky note service devices 200 perform processes on the pasteboards and sticky notes which are displayed on the screens of the sticky note information processing devices (the display device 270 and the respective personal terminals 280).

In an example of FIG. 3D, the display device 270, the personal terminal 280A, the personal terminal 280B, and the personal terminal 280C are installed and a meeting is performed in a conference room 380. The display device 270, the personal terminal 280A, the personal terminal 280B, and the personal terminal 280C are connected to each other through the communication line 299.

Further, the sticky note service device 200 and the device in the conference room 380 are connected to each other through the communication line 390. The communication line 390 may be a wireless line, a wired line, or the combination thereof, and may be, for example, the Internet, the intranet, or the like as a communication infrastructure. In addition, the function which is performed by the sticky note service device 200 may be realized as the cloud service. The display device 270 may transmit the display of the screen of the display device 270 to each of the personal terminals 280 using the sticky note service device 200, and may display the screen of the display device 270 on the screen of each of the personal terminals 280. In addition, the display device 270 and each of the personal terminals 280 may use the sticky note service device 200, respectively.

FIGS. 4A to 4C are explanatory diagrams illustrating an example of the conference room or the like and examples of the use of the display device 270 and the personal terminal 280 according to the exemplary embodiment.

As illustrated in the example of FIG. 4A, participants 411 and 412, and a facilitator 421 are gathered in the conference room or the like. The participant 411 uses the personal terminal 280A and the participant 412 uses the personal terminal 280B. Generally, one terminal device (personal terminal 280A or the like) is given to one participant, the terminal device is a tablet-type terminal which has a size of an approximately note (for example, A4, B5, 7 to 10 inches, or the like) like the personal terminal 280 illustrated in the example of FIG. 4C and is operated using a finger, a pen, or the like. Sticky note information, in which text data, handwritten characters, figures, or the like are described, is prepared by each of the participants. Meanwhile, the terminal device is not limited to the tablet-type terminal and may be a PC (including a laptop) which includes a keyboard, a mouse, and the like.

A display device 270x, which is illustrated in the example of FIG. 4A, is a projector, and displays a pasteboard and a sticky note. In addition, a display device 270y is an electronic white board, and receives an operation of pasting a sticky note to the pasteboard (table) by detecting the motion of the finger, the pen, or the like of the facilitator 421, an operation of moving a sticky note, an operation of associating (grouping) sticky notes, or the like. For example, as illustrated in the example of FIG. 4A, sticky notes are displayed on the pasteboard in the display device 270y. For example, a pen is provided in the display device 270y. The operations performed on the pasteboard and the sticky notes are received by detecting a case in which the pen is separated from a predetermined pen holder (the facilitator 421 raises the pen to perform an operation) and a case in which the position of the tip of the pen (the tip of the pen comes into contact with the display device 270y). For example, a sensor (a sensor, which has a switch that is turned on or off by the gravity of the pen, or the like) is provided in the pen holder, and a pen, which is used, of plural pens (a black color pen, a red color pen, a blue color pen, and the like) may be detected. In addition, the whole display screen of the display device 270y may be a touch sensor, and the position at which the pen comes into contact with the display screen, and pressure may be detected. In addition, the display device 270 may be an electronic board as illustrated in the example of FIG. 4B. The electronic board generally includes a large-screened display device (which is at least larger than the display devices of the personal terminals 280). The display device is a touch panel, and detects the position at which the pen comes into contact with the display screen, and pressure. For example, the screen may have a size of 80 inches.

FIG. 9 is a flowchart illustrating an example of a process according to the exemplary embodiment.

In step S902, the log extracting module 110 extracts a target log.

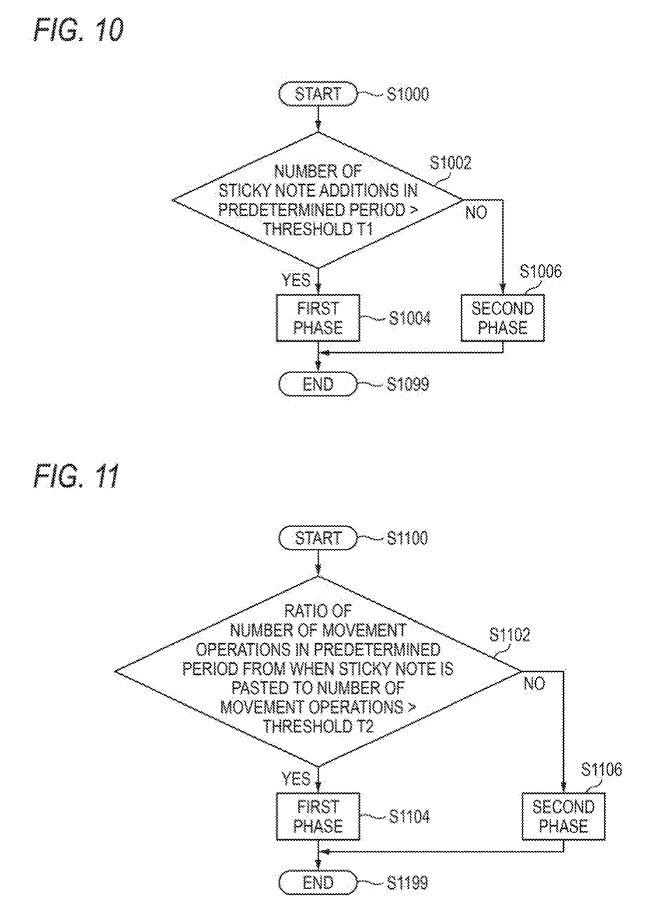

In step S904, the phase determination module 130 determines a phase from the extracted log. The details of step S904 will be described later with reference to FIGS. 10 to 15.

In step S906, the phase presentation module 150 presents the phase which is the result of determination performed in step S904.

In step S908, the phase correspondence module 160 provides a function according to the phase as described above.

FIG. 10 is a flowchart illustrating an example of a process according to the exemplary embodiment.

In step S1002, it is determined whether or not the “number of sticky note additions in a predetermined period>threshold T1”. In a case that the “number of sticky note additions in the predetermined period>threshold T1”, the process proceeds to step S1004. Otherwise, the process proceeds to step S1006. The “predetermined period” may be designated as, for example, past five minutes, five minutes from when the meeting starts, and the like. The “number of sticky note additions” refers to the number of times in which sticky notes are newly pasted in the pasteboard.

In step S1004, it is determined to be the first phase. The reason for this is that a large number of sticky notes are generated per time, and thus idea issue or the like is performed in step S1006, it is determined to be the second phase.

FIG. 11 is a flowchart illustrating an example of a process according to the exemplary embodiment.

In step S1102, it is determined whether or not “a ratio of the number of movement operations in a predetermined period from when a sticky note is pasted to the number of movement operations>threshold T2”. In a case that “the ratio of the number of movement operations in a predetermined period from when a sticky note is pasted to the number of movement operations>threshold T2”, the process proceeds to step S1104. Otherwise, the process proceeds to step S1106. The “number of movement operations”, which is the denominator, indicates the entire number of movement operations up to the present time in the meeting. The “number of movement operations in the predetermined period from when the sticky note is pasted”, which is the numerator, indicates the number of times in which the sticky note is moved, for example, for five minutes from time at which the sticky note is initially pasted to the pasteboard. For example, a case, in which the sticky note is moved immediately after being pasted, corresponds thereto.

In step S1104, it is determined to be the first phase. For example, even if the sticky note is moved a large number of times, it is not the movement for “convergence” but trial-and-error movement in the predetermined period after the sticky note is pasted.

In step S1106, it is determined to be the second phase.

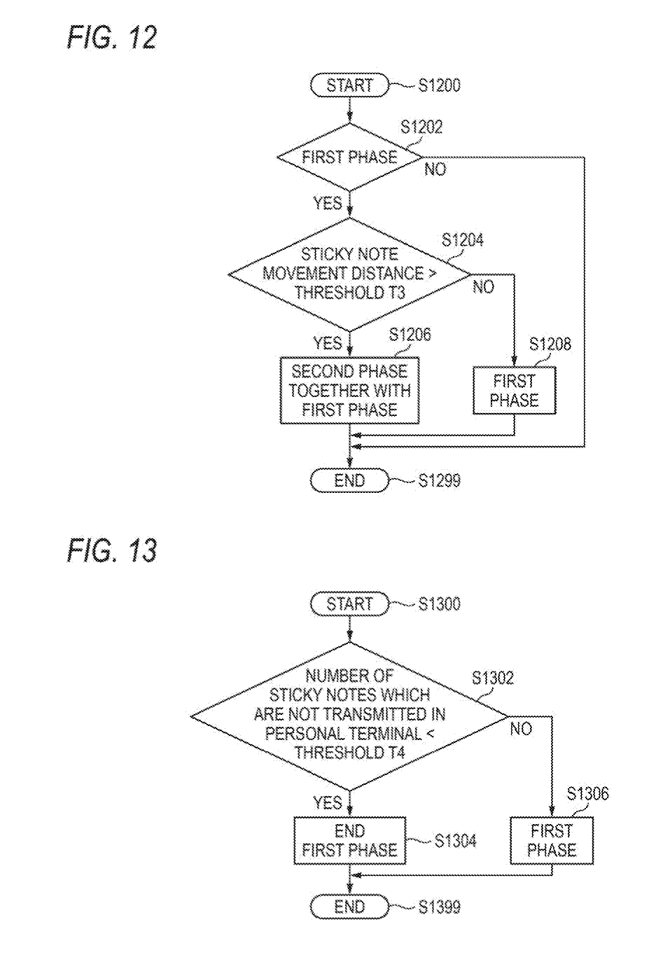

FIG. 12 is a flowchart illustrating an example of a process according to the exemplary embodiment.

In step S1202, it is determined whether or not it is the first phase. In a case of the first phase, the process proceeds to step S1204. Otherwise, the process ends (step S1299).

In step S1204, it is determined whether or not “sticky note movement distance>threshold T3”. In a case that “sticky note movement distance>threshold T3”, the process proceeds to step S1206. Otherwise, the process proceeds to step S1208.

In step S1206, it is determined to be the second phase together with the first phase. Meanwhile, in this case, a message, in which the first phase and the second phase are clearly divided, may be presented to the facilitator.

In step S1208, it is determined to be the first phase.

In addition, the condition in S1204 may be changed to ““sticky note movement distance (actual movement distance)”/“sticky note movement distance (straight-line distance)”>threshold””. The reason for this is that, if the sticky notes are hesitatingly moved in many cases, it is determined to be both the first phase and the second phase in many cases.

FIG. 13 is a flowchart illustrating an example of a process according to the exemplary embodiment.

In step S1302, it is determined whether “the number of sticky notes which are not transmitted in the personal terminal 280<threshold T4”. In a case that “the number of sticky notes which are not transmitted in the personal terminal 280<threshold T4”, the process proceeds to step S1304. Otherwise, the process proceeds to step S1306.

In step S1302, “the number of sticky notes which are not transmitted in the personal terminals 280<threshold T4” may be, for example, the sum of the number of sticky notes which are not transmitted in the whole personal terminals 280 or may be the average, the intermediate value, the mode value, the maximum number, the minimum number, or the like of the number of sticky notes, which are not transmitted, in the personal terminals 280.

In step S1304, the first phase ends. The reason for this is that there are a small number of sticky notes which are prepared by the participants. Meanwhile, in this case, a message which should be transitioned to the second phase may be presented to the facilitator.

In step S1306, it is determined to be the first phase.

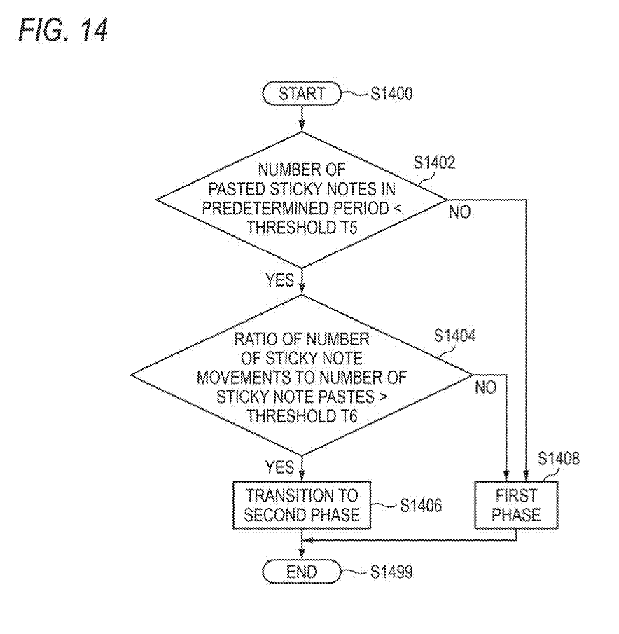

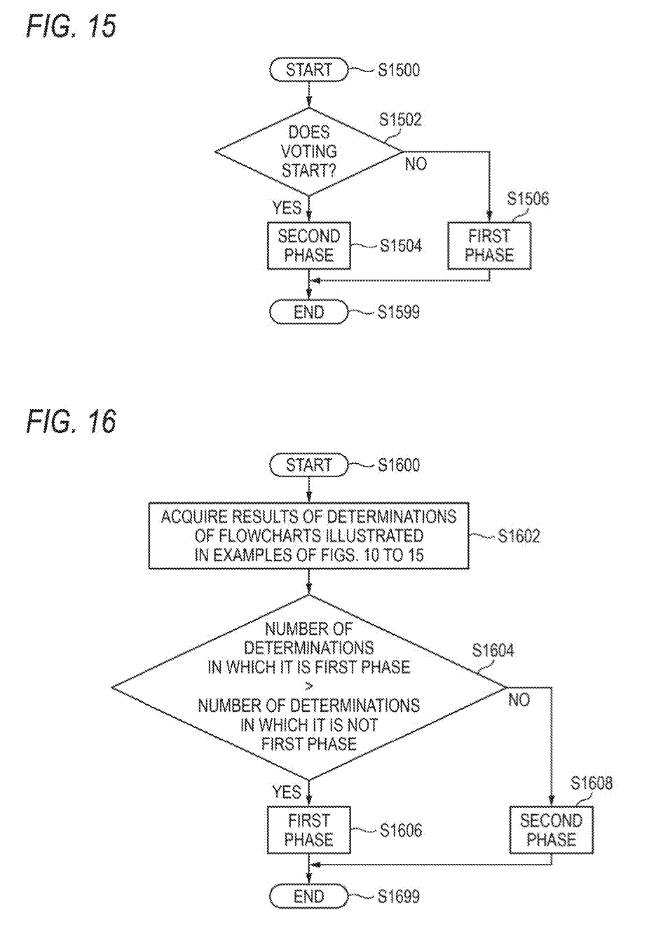

FIG. 14 is a flowchart illustrating an example of a process according to the exemplary embodiment.

In step S1402, it is determined whether or not the “number of pasted sticky notes in the predetermined period<threshold T5”. In a case that the “number of pasted sticky notes in the predetermined period<threshold T5”, the process proceeds to step S1404. Otherwise, the process proceeds to step S1408.

In step S1404, it is determined whether or not “a ratio of the number of sticky note movements to the number of sticky note pastes>threshold T6”. In a case that “the ratio of the number of sticky note movements to the number of sticky note pastes>threshold T6”, the process proceeds to step S1406. Otherwise, the process proceeds to step S1408.

In step S1406, it is determined to be transition to the second phase. The reason for this is that the number of newly pasted sticky notes is small and the number of movement operations is large.

In step S1408, it is determined to be the first phase.

FIG. 15 is a flowchart illustrating an example of a process according to the exemplary embodiment.

In step S1502, it is determined whether or not voting starts. In a case that voting starts, the process proceeds to step S1504. Otherwise, the process proceeds to step S1506. The “voting” is a selection operation of displaying intentions of the participants (for example, content written in the sticky note should be employed) on the sticky notes on the pasteboard or the group.

In step S1504, it is determined to be the second phase. The reason for this is that “voting” which should be performed on step of convergence is performed.

In step S1506, it is determined to be the first phase.

FIG. 16 is a flowchart illustrating an example of a process according to the exemplary embodiment. In the example, plural conditions are combined.

In step S1602, the results of determinations of the flowcharts illustrated in the examples of FIGS. 10 to 15 are acquired.

In step S1604, it is determined whether or not “the number of determinations in which it is the first phase>the number of determinations in which it is not the first phase”. In a case that “the number of determinations in which it is the first phase>the number of determinations in which it is not the first phase”, the process proceeds to step S1606. Otherwise, the process proceeds to step S1608.

In step S1606, it is determined to be the first phase.

In step S1608, it is determined to be the second phase.

Meanwhile, in a case that it is determined to be not the first phase in all of the conditions in step S1604, it may be determined to be the second phase.

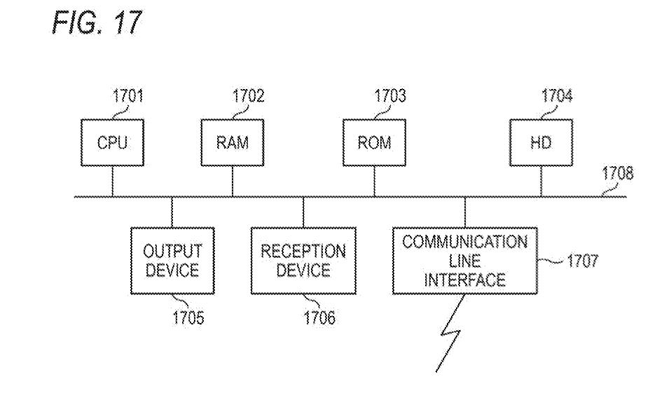

Meanwhile, the hardware configuration of a computer, in which a program as the exemplary embodiment is executed, is a general computer as illustrated in FIG. 17, and, specifically, a personal computer, a computer which may be a server, or the like. That is, as a detailed example, a CPU 1701 is used as a processing unit (arithmetic unit), and a RAM 1702, a ROM 1703, and an HD 1704 are used as a storage device. For example, a hard disk or a solid state drive (SSD) is used as the HD 1704. The computer includes the CPU 1701 which executes programs, such as the log extracting module 110, the phase determination module 130, the phase processing module 140, the phase presentation module 150, the phase correspondence module 160, the display module 272, the pasteboard and sticky note operating module 274, the display module 282, the pasteboard and sticky note operating module 284, the display information configuration module 205, the sticky note managing module 210, the pasteboard function managing module 215, the using pasteboard managing module 220, the phase monitoring module 225, the pasteboard operating module 230, and the sticky note preparing and operating module 235, the RAM 1702 which stores the programs and data, the ROM 1703 which stores a program or the like that starts the computer, the HD 1704 which is a subsidiary storage device (which may be a flash memory or the like) that has functions of the determination condition storage module 120, the sticky note and pasteboard information DB 240, and the operation information DB 245, a reception device 1706 which receives data based on an operation performed on a keyboard, a mouse, a touch screen, a microphone, or the like by a user, an output device 1705, such as a CRT, a liquid crystal display, and a speaker, a communication line interface 1707 which is connected to a communication network, such as a network interface card, and a bus 1708 which is used to exchange data by connecting the above units. Plural computers may be connected to each other through a network.

In the above-described exemplary embodiment, in a case of a computer program, a system having the hardware configuration is caused to read the computer program, which is software, and the above-described exemplary embodiment is realized in such a way that the software cooperates with hardware resources.

Meanwhile, the hardware configuration illustrated in FIG. 17 illustrates one example of the configuration, and the exemplary embodiment is not limited to the configuration illustrated in FIG. 17, and may have a configuration in which it is possible to execute the modules described in the exemplary embodiment. For example, some modules may be formed by dedicated hardware (for example, application specific integrated circuit (ASIC) or the like), some modules may be included in an external system and connected by a communication line, and, further, plural systems illustrated in FIG. 17 may be connected with each other by the communication line so as to perform cooperative operations with each other. In addition, specifically, the modules may be embedded into a mobile information communication device (which includes a mobile phone, a smart phone, a mobile device, a wearable computer, and the like), a home information appliance, a robot, a copying machine, a facsimile, a scanner, a printer, a multifunction machine (an image processing device which has two or more functions of the scanner, the printer, the copying machine, and the facsimile) in addition to the personal computer.

In addition, in a comparison process in the above-described exemplary embodiment, “equal to or greater than”, “equal to or smaller than”, “larger than”, “smaller than (less)” may indicate “larger than”, “smaller than (less)”, “equal to or greater than”, and “equal to or smaller than”, respectively, unless it is not incompatible with their combination.

Meanwhile, the above-described program may be provided after being stored in the recording medium or the program may be provided by a communication unit. In this case, for example, the above-described program may be understood as the invention of a “computer readable recording medium storing a program”.

The “computer readable recording medium storing a program” indicates a computer readable recording medium in which a program is recorded, the computer readable recording medium being used for installation, execution, and distribution of the program.

Meanwhile, the recording medium includes, for example, a “DVD-R, a DVD-RW, a DVD-RAM, and the like”, which are Digital Versatile Disks (DVD) and are standards formulated in a DVD forum, a “DVD+R, a DVD+RW, and the like” which are standards formulated at the DVD+RW, a read-only memory (CD-ROM), a CD recordable (CD-R), a CD rewritable (CD-RW), and the like which are Compact Disks (CD), a Blu-ray (registered trade mark) Disc, a magneto-optical (MO) disk, a flexible disk (FD), a magnetic tape, a hard disk, a read-only memory (ROM), an Electrically Erasable Programmable Read-Only Memory (EEPROM (registered trade mark)), a flash memory, a random access memory (RAM), a secure digital (SD) memory card, and the like.

Further, the whole or a part of the program may be preserved or distributed after being recorded in the recording medium. In addition, the program may be transmitted through a transmission medium, such as a wired network, a wireless communication network, or the combination thereof, which is used for, for example, a local area network (LAN), a metropolitan area network (MAN), a wide area network (WAN), the Internet, the intranet, the extranet, or the like depending on communication. In addition, the program may be transported by being placed on carrier waves.

Furthermore, the program may be a part or the whole of another program, or may be recorded in a recording medium together with an individual program. In addition, the program may be divided and recorded in plural recording media. In addition, if it is possible to restore the program, the program may be recorded in any type of manner such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an extraction unit that extracts a history of operations performed on a sticky note which is attached to a pasteboard; and
a presentation unit that, in a case that the history of the operations satisfies a predetermined condition, performs presentation which indicates a situation in a meeting corresponding to the predetermined condition.

2. The information processing device according to claim 1, wherein the predetermined condition is determined to a first situation in a case that the number of added sticky notes in a predetermined period is equal to or greater than a predetermined threshold.

3. The information processing device according to claim 1, wherein the predetermined condition is determined to a first situation in a case that the predetermined condition indicates that a ratio of the number of movement operations to the number of movement operations in a predetermined period from when the sticky note is pasted is equal to or greater than a predetermined threshold.

4. The information processing device according to claim 1, wherein the predetermined condition is determined to both of a first situation and a second situation in a case that a sticky note movement distance is equal to or greater than a predetermined threshold in the first situation.

5. The information processing device according to claim 1, wherein the predetermined condition is determined to an end of a first situation in a case that the number of sticky notes which are not transmitted in a personal terminal is equal to or smaller than a predetermined threshold.

6. The information processing device according to claim 1, wherein the predetermined condition is determined to a transition to a second situation in a case that the number of pasted sticky notes in a predetermined period is equal to or smaller than a predetermined threshold and a ratio of the number of sticky note movements to the number of pasted sticky notes is equal to or greater than a predetermined threshold.

7. The information processing device according to claim 1, wherein the predetermined condition is determined to a second situation in a case that a voting is started.

8. The information processing device according to claim 2, further comprising:
a threshold changing unit that changes the predetermined threshold according to the number of people who participate in the meeting or according to whether or not the meeting is in progress.

9. The information processing device according to claim 3, further comprising:
a threshold changing unit that changes the predetermined threshold according to the number of people who participate in the meeting or according to whether or not the meeting is in progress.

10. The information processing device according to claim 4, further comprising:
a threshold changing unit that changes the predetermined threshold according to the number of people who participate in the meeting or according to whether or not the meeting is in progress.

11. The information processing device according to claim 5, further comprising:
a threshold changing unit that changes the predetermined threshold according to the number of people who participate in the meeting or according to whether or not the meeting is in progress.

12. The information processing device according to claim 6, further comprising:
a threshold changing unit that changes the predetermined threshold according to the number of people who participate in the meeting or according to whether or not the meeting is in progress.

13. The information processing device according to claim 7, further comprising:
a threshold changing unit that changes the predetermined threshold according to the number of people who participate in the meeting or according to whether or not the meeting is in progress.

14. An information processing method, comprising
extracting a history of operations performed on a sticky note which is attached to a pasteboard; and
in a case that the history of the operations satisfies a predetermined condition, performing presentation which indicates a situation in a meeting corresponding to the predetermined condition.

15. A non-transitory computer readable medium storing an information processing program causing a computer to function as:
an extraction unit that extracts a history of operations performed on a sticky note which is attached to a pasteboard; and
a presentation unit that, in a case that the history of the operations satisfies a predetermined condition, performs presentation which indicates a situation in a meeting corresponding to the predetermined condition.
